(19) United States
(12) Patent Application Publication
(10) Pub. No.: US 2025/0011609 A1
(43) Pub. Date: Jan. 9, 2025

(54) CARBON NANOTUBE FLUID MATRIX

(71) Applicant: Nano-C, Inc., Westwood, MA (US)

(72) Inventor: Melissa J. RICCI, Dedham, MA (US)

(21) Appl. No.: 18/708,848

(22) PCT Filed: Nov. 10, 2022
(86) PCT No.: PCT/US2022/079608

§ 371 Date: May 9, 2024

Related U.S. Application Data
(60) Provisional application No. 63/277,910, filed on Nov. 10, 2021.

(51) Int. Cl. C09D 11/32; C01B 32/159; C01B 32/174; C09D 11/033; C09D 11/037

(52) U.S. Cl. CPC C09D 11/32; C01B 32/159; C01B 32/174; C09D 11/033; C09D 11/037; C01B 2202/02; C01B 2202/06; C01B 2202/28

(57) ABSTRACT

Carbon nanotube fluid matrices, methods of producing carbon fluid matrices and the use of the carbon fluid matrices for printing. In accordance with certain embodiments, the carbon fluid matrices are free of surfactants, polymers and additives typically required for stable formulations.

### CROSS REFERENCE TO RELATED APPLICATION

This application claims the benefit of and priority to U.S. Provisional Patent Application No. 63/277,910, filed Nov. 10, 2021, the entire content of which is herein incorporated by reference.

### FIELD

This application is directed to carbon nanotube fluid matrices. In particular, this application is directed to carbon nanotube fluid matrices, methods of preparing carbon nanotube fluid matrices and uses of such matrices.

### BACKGROUND

Nanotubes are members of the fullerene structural family, which also includes the spherical buckyballs, and the ends of a nanotube may be capped with a hemisphere of the buckyball structure. Their name is derived from their long, hollow structure with the walls formed by atomically thick sheets of carbon, called graphene. These sheets are rolled at specific and discrete (“chiral”) angles, and the combination of the rolling angle and radius decides the nanotube properties; for example, whether the nanotube behaves as a metal or semiconductor. Nanotubes are categorized as single-walled carbon nanotubes (SWCNT) and multi-walled carbon nanotubes (MWCNT). While single-walled carbon nanotubes contain one single folded graphene sheet, multi-walled carbon nanotubes include multiple rolled layers (concentric tubes) of graphite.

Single-walled carbon nanotubes are characterized by their unique mechanical, electrical and optical properties. The tensile strength of individual single-walled carbon nanotubes can be well over 30 GPa and electrical conductance of metallic single-walled carbon nanotubes ropes approach 10⁶ S/m. Formed after deposition of single-walled carbon nanotube dispersions, single-walled carbon nanotube networks also allow visible and infrared light transmission in the direction normal to the plane of the film. This property arises from the extremely small diameters (<1.5 nm average) of the single-walled carbon nanotubes coupled with the huge aspect (i.e., length-to-diameter) ratio with typical values of 1000-1500. Thus, the formation of transparent conductive networks is possible. The combination of such properties in a single material marks them as distinctive candidates for a multitude of lab-demonstrated applications like field effect transistors, non-volatile memories, displays, touch screens, battery electrodes, supercapacitors and filtration membranes.

After their formation, such carbon nanotube dispersions can be either mixed with solutions of other materials, e.g., polymers of which electrical conductivity is intended to be increased or deposited on substrates using established coating techniques such as dip- and spray-coating or inkjet printing.

As produced raw carbon nanotube soots generally include material impurities (extraneous impurities), such as transition metal catalysts, graphitic carbons, amorphous carbon nanoparticles, fullerenes, carbon anions, polycyclic aromatic hydrocarbons along with the desired carbon nanotube products. The nature and degree of the electronic impurities in a given raw material can depend on the method of synthesis, such as, for example, laser, arc, High-Pressure Carbon Monoxide Conversion (HiPco), chemical vapor deposition (CVD), or combustion.

Known purification protocols generally involve steps of generic unit operations like pre-oxidation, acid reflux, mechanical mixing, ultrasonication, filtration, neutralization, and centrifugation. Selecting a suitable combination depends upon the method of production of the carbon nanotubes and the specific impurity targeted. Extraneous impurities, such as catalyst metal particles, fullerenic carbon, amorphous carbon, graphitic carbon, and carbon onions, are present to different degrees in as prepared raw carbon nanotube samples. Oxidative chemical treatments as part of the purification protocol and multiple acid treatments as part of the typical purification processes result in reasonably clean carbon nanotubes (<0.5 wt % relative to metal residue). However, an aggressive chemical purification can result in a loss of conductive pathways, which leads to a drastic fall in the single tube electrical conductance as well as the elimination of the inter-band optical transitions arising from the van Hove singularities. Accordingly, for many applications, especially applications requiring a combination of optical and electrical properties retaining the electronic structure of the carbon nanotubes substantially intact is an important aspect in the formation of single-walled carbon nanotube inks.

In accordance with certain purification procedures, carbon nanotubes are purified using a combination of sulfuric acid and nitric acid, which provides metals removal and oxidation in one step. This process can generate a high fluid content, highly debundled, concentrated “wet paste.” In accordance with other purification procedures, carbon nanotubes are purified using a combination of phosphoric acid and nitric acid. Carbon nanotube practical advantages and theoretical performance boosts in applications are generally most greatly realized when the purified, debundled, carbon nanotube material is maintained in its debundled state throughout device/product/process application.

Carbon Nanotube (CNT) dispersions in water or other common solvents typically are thermodynamically unstable, meaning carbon nanotube bundles can increase in diameter or flocculate, ultimately leading to a de-stabilized dispersion, which is undesirable for coating CNT on a surface. If the CNT bundles grow in size or assembly by flocculation in the coating solution, i.e. before the film is formed, then further assembly of the film is compromised and the resulting dry coating exhibits higher surface resistivity at a given mass deposition per unit area. Furthermore, dispersions of small particles and CNT are typically formed from solvents and dispersing aids like surfactants or other additives like polymers. However, the additives will also be deposited in the coating as the solvent evaporates and will interfere with formation of the conductive network. This results in sub-optimal electronic performance for the thin film.

There is a need for stable carbon nanotube fluid matrices comprising CNTs uniformly distributed within a solvent, wherein the CNTs do not flocculate for an extended period of time such as 12 to 24 hours or longer. Furthermore, there is a need for carbon nanotube fluid matrices that are free of surfactants, polymers and other additives that can interfere with desirable properties of the coated or printed film.

### SUMMARY

The present application is directed to carbon nanotube fluid matrices, methods of producing carbon fluid matrices and the use of the carbon fluid matrices for printing. In accordance with certain embodiments, the carbon fluid matrices are free of surfactants, polymers and additives typically required for stable formulations.

In some aspects, a stable carbon nanotube fluid matrix containing carbon nanotubes dispersed in a solvent mixture is disclosed. The solvent mixture includes a first solvent and a second solvent, wherein:
a) the first solvent has a boiling point below 100° C. and the second solvent has a boiling point above 100° C. or
b) the first solvent is a monohydric alcohol and the second solvent is a diol.

In some embodiments, the stable carbon nanotube fluid matrix is stable over a concentration range of from about 1 mg/L to about 3000 mg/L.

In some embodiments, the first solvent is selected from the group consisting of hexane, isopropanol, n-propanol, methanol, ethanol, benzene, acetonitrile, tetrahydrofuran, and mixtures thereof.

In some embodiments, the second solvent is selected from the group consisting of, propylene glycol methyl ether, dimethylformamide, n-methyl pyrrolidone, dimethylacetamide, dimethylsulfoxide, cyrene, butanol, toluene, xylenes, chlorobenzene, dichlorobenzene, ethylene glycol, propylene glycol, glycerol, methyl lactate, cyclohexanol, and mixtures thereof.

In some embodiments, the first solvent is selected from isopropyl alcohol, ethanol, n-propanol, methanol, or mixtures thereof.

In some embodiments, the second solvent is cyclohexanol, ethylene glycol or propylene glycol.

In some embodiments, the solvent mixture includes at least one monohydric alcohol and at least one diol.

In some embodiments, the solvent mixture includes cyclohexanol, isopropyl alcohol and ethylene glycol.

In some embodiments, the stable carbon nanotube fluid matrix is free of surfactants, dispersant aids and polymers.

In some embodiments, the solvent mixture consists essentially of water, the first solvent and the second solvent.

In some embodiments, the carbon nanotubes are functionalized. In some embodiments, the carbon nanotubes are functionalized with a plurality of oxygen containing functional groups.

In some embodiments, the carbon nanotubes include single walled carbon nanotubes, multi-walled carbon nanotubes or mixtures thereof.

In some embodiments, the solvent mixture includes ethylene glycol, cyclohexanol and propylene glycol.

In some embodiments, the solvent mixture includes cyrene.

In accordance with another aspect, a stable carbon nanotube fluid matrix including functionalized carbon nanotubes dispersed in a solvent mixture, wherein the stable carbon nanotube fluid matrix is free of surfactants, dispersant aids and polymers and the stable carbon nanotube fluid matrix is stable up to a concentration of about 3000 mg/L is disclosed.

In accordance with another aspect, a method of producing a stable carbon nanotube fluid matrix includes providing a carbon nanotube composition comprising oxidized carbon nanotubes and dispersing the carbon nanotube composition in a solvent mixture including a first solvent and a second solvent, wherein
a) the first solvent has a boiling point below 100° C. and the second solvent has a boiling point above 100° C. or
b) the first solvent is a monohydric alcohol and the second solvent is a diol to provide a stable carbon nanotube fluid matrix is disclosed.

In some embodiments, the first solvent is removed from the carbon nanotube fluid matrix to produce a concentrated carbon nanotube fluid matrix.

In accordance with another aspect, a method of coating or printing on a substrate includes providing a concentrated carbon nanotube fluid matrix and printing or coating the concentrated carbon nanotube fluid matrix on a substrate.

In some embodiments, the concentrated carbon nanotube fluid matrix is screen printed on the substrate.

In some embodiments, the solvent mixture includes ethylene glycol, cyclohexanol and propylene glycol.

In accordance with another aspect, a stable graphene fluid matrix is disclosed, which includes graphene dispersed in a solvent mixture including a first solvent and a second solvent, wherein:
a) the first solvent has a boiling point below 100° C. and the second solvent has a boiling point above 100° C. or
b) the first solvent is a monohydric alcohol and the second solvent is a diol.

### DETAILED DESCRIPTION OF THE INVENTION

It should be noted that as produced carbon nanotube raw material, purified carbon nanotube materials, fullerenes, and/or any other fullerenic materials can be synthesized and/or processed by the approaches described, for example, in Howard et al., U.S. Pat. No. 5,273,729, filed May 24, 1991, Howard et al., U.S. Pat. No. 5,985,232, filed Sep. 11, 1996, Height et al., U.S. Pat. Nos. 7,335,344 and 7,887,775 B2, filed Mar. 14, 2003, Kronholm et al. U.S. Pat. No. 7,435,403, filed Jul. 3, 2003, and Howard et al., U.S. Pat. Nos. 7,396,520 and 7,771,692 filed Jan. 21, 2005, which are hereby incorporated by reference herein in their entireties.

In some embodiments, the carbon nanotubes are single-walled carbon nanotubes. In other embodiments, the carbon nanotubes are multi-walled carbon nanotubes. For example, in some non-limiting embodiments, the nanotubes have at least two walls (i.e., double-walled). In other embodiments, the nanotubes have 3 to 12 walls. In further embodiments, the nanotubes have less than 12 walls. In yet another embodiment, the nanotubes have between 2 and 6 walls. In some embodiments, the carbon nanotubes have between 2 and 8 walls. In further embodiments, the carbon nanotubes have between 2 and 10 walls. In exemplary non-limiting embodiments, the carbon nanotubes have 2, 4, 6, 8, 10 or 12 walls.

In another embodiment, mixtures of single and multi-walled carbon nanotubes are provided. For example, in some embodiments, a mixture of single and double walled nanotubes is provided. In further embodiments, a mixture of single nanotubes and multi-walled nanotubes is provided. In another embodiment, a mixture of multi-walled carbon nanotubes is provided, in which the mixture includes nanotubes having various walled configurations. The compositions and matrices disclosed herein could also be used with graphene as well as CNTs and combinations thereof.

The term “stable” as used in reference to a CNT or graphene formulation or fluid matrix as used herein refers to a formulation or fluid matrix containing CNT or graphene that will withstand centrifugation of at least 10,000 g for at least 30 minutes, and give an optical density of at least about 0.1 at 550 nm.

The term “surfactant” as used herein refers to a compound that lowers the interfacial tension between the carbon nano tube and the fluid. The surfactant may be associated with the carbon nanotube surface by covalent or ionic bonds or pi-stacking and may be wrapped around the carbon nanotube.

The term “dispersal aid/stabilizing additive” as used herein refers to a non-nanotube component present in the fluid matrix alongside the carbon nanotubes in order to provide stabilization, that remains present in the carbon nanotube matrix after the fluid matrix has evaporated.

The term “fluid” as used herein refers to a liquid wherein the viscosity of the liquid is less than about 3 Poise at 25° C.

The term “functionalized carbon nanotubes” as used herein refers carbon nanotubes having an atom or a group of atoms attached to the carbon nanotube sidewall or endcap. This association could be by covalent bond, in which the carbon nanotube sp² hybridized structure may be disrupted, as well as non-covalent means such as pi-stacking, dipole-dipole forces, or van-der-walls interaction.

The term “oxidized carbon nanotubes” as used herein refers to functionalized carbon nanotubes bearing oxygen-containing functional surface groups, such as carboxylic, ketone, lactone, anhydride or hydroxyl functionalities.

Discrete oxidized carbon nanotubes may be obtained from as-produced bundled carbon nanotubes by various methods. An example of one such method is oxidation using a combination of concentrated acids, such as phosphoric, sulfuric and/or nitric acids. The techniques disclosed in PCT/US09/68781 and PCT/US2021/053319, the disclosures of which are incorporated herein by reference, are particularly useful in producing the discrete carbon nanotubes used in certain embodiments of the present invention. The bundled carbon nanotubes can be made from any known means such as, for example, chemical vapor deposition, laser ablation, and high pressure carbon monoxide synthesis. The bundled carbon nanotubes can be present in a variety of forms including, for example, soot, powder, fibers, and bucky paper. Furthermore, the bundled carbon nanotubes may be of any length, diameter, or chirality. Carbon nanotubes may be metallic, semi-metallic, semi-conducting, or non-metallic based on their chirality and number of walls.

CNT pastes prepared in accordance with the description in PCT/US2021/053319 are particularly useful in that the CNT paste can be dispersed at relatively high concentration, in a large variety of solvents, by virtue of the paste feedstock particularly that produced in the disclosed phosphoric acid process. In accordance with some aspects, the CNT matrices disclosed herein can be produced without the use of any dispersal aid or stability-promoting additive.

The discrete oxidized carbon nanotubes may include, for example, single-wall, double-wall carbon nanotubes, or multi-wall carbon nanotubes and combinations thereof.

Carbon nanotubes purified through the oxidation processes can be incorporated with water, aqueous/mixed solvent systems, and purely organic systems, but also allow other possibilities including high viscosity solvents, monomers, and polymers, where dispersion stability can be aided and promoted through a high viscosity vehicle, rather than be solely dictated by solubility parameters/surface tension.

While sprayable and rod-coatable inks are useful in many processes to apply the inks, screen printing is another process application that is common. Screen-printable inks have large morphological differences vs. rod-coatable and sprayable inks, most notably in viscosity, where high viscosity solvents such as cyclohexanol are commonly utilized.

In accordance with certain aspects of the present invention, carbon nanotubes are capable of forming stable matrices in various solvents by combining low boiling point solvents with high boiling point solvents. Low boiling point solvents typically are those with boiling points below about 100° C., more particularly at or below about 80° C. High boiling point solvents typically are those with boiling points over about 100° C., more particularly over about 130° C. and still more particularly over about 150° C. Particularly useful solvents are those with a boiling point of about 150° C. or higher with a surface tension of about 30 dynes/cm or higher. In some embodiments, water may be used in place of the low boiling point solvent. Although not wishing to be bound by theory, it is thought that the use of a higher boiling solvent with the dual boiling ranges is beneficial in that the high boiler behaves as the film forming agent, to prepare a stable wet film such that the dual composition can be applied with a roll to roll (“R2R”)-ready process such as slot die, gravure, or flexo printing.

In accordance with some embodiments, the one or more of the first solvents comprise about 5 and 95% and one or more of the second solvents comprise between about 5 and 95% by weight of the total formulation, or one or more of the first solvents comprise between about 15 and 80% and one or more of the second solvents comprise between about 15 and 85% by weight of the total formulation, or one or more of the first solvents comprise between about 20 and 70% and one or more of the second solvents comprise between about 20 and 70% by weight of the total formulation, or one or more of the first solvents comprise between about 25 and 50% and one or more of the second solvents comprise between about 50 and 65% by weight of the total formulation. The compositions disclosed herein may also include water in addition to the first and second solvents.

Solvent combinations can be tested for miscibility to provide an indication if the solvent mixture would provide a stable in accordance with the present disclosure. Representative miscibility test results are provided below:

| | amount | | |
|---|---|---|---|
| | (g) | % | bp (° C.) |
| Miscibility | | | |
| study | | | |
| IPA | 4.23 | 27.57% | |
| water | 1.98 | 12.90% | |
| 1-butanol | 4.65 | 30.32% | 117 |
| 1,2-butanediol | 4.48 | 29.22% | 192 |
| | 15.34 | 100.00% | |
| Miscible? | yes | | |
| IPA | 4.23 | 27.57% | |
| water | 1.98 | 12.90% | |
| 1-octanol | 4.65 | 30.32% | 195 |
| hexanediol | 4.48 | 29.22% | 223 |
| | 15.34 | 100.00% | |
| Miscible? | yes | | |
| 1267-25-3 | | | |
| IPA | 4.23 | 27.57% | |
| water | 1.98 | 12.90% | |
| 1-butanol | 4.65 | 30.32% | 117 |
| hexanediol | 4.48 | 29.22% | 223 |
| | 15.34 | 100.00% | |
| Miscible? | yes | | |
| 1267-25-4 | | | |
| IPA | 4.23 | 27.57% | |
| water | 1.98 | 12.90% | |
| 1-octanol | 4.65 | 30.32% | 195 |
| hexanediol | 4.48 | 29.22% | 223 |
| | 15.34 | 100.00% | |
| Miscible? | yes | | |

In accordance with certain embodiments, the process disclosed herein can provide stable carbon nanotube dispersions, wherein the carbon nanotube content, as determined by optical density at 550 nm, is between around 0.01 absorbance units to around 40 absorbance units, more particularly between about 0.1 absorbance units to around 20 absorbance units. In a typical optical density measurement, the high concentration dispersion is diluted 10:1 or similarly to allow measurement in the working range of the UV-Vis or UV-Vis monochrometer, typically between about 0.1 and about 2 absorbance units. Depending on the desired coating method and substrate, the final concentration optical density should be approximately 0.1-5 absorbance units for ultrasonic spray-coatable inks, and optical density between around 5 to around 20 absorbance units for slot-die or rod-coatable inks. Through mass balance methods, it was determined for one of the carbon nanotube compositions that carbon nanotube concentration was 315 mg/L at an optical density of 14 absorbance units.

In accordance with some embodiments, the carbon nanotube fluid matrix is stable up to a concentration of about 3000 mg/L, up to about 2000 mg/L, up to about 1000 mg/L, up to about 750 mg/L, or up to about 500 mg/L.

In accordance with some embodiments, a stable carbon nanotube fluid matrix is provided, wherein the fluid matrix is stable over a concentration range of from about 100 mgl mg/L to about 3000 mg/L, over a concentration range of from about 10 mg/L to about 500 mg/L, over a concentration range of from about 20 mg/L to about 400 mg/L, or over a concentration range of from about 30 mg/L to about 300 mg/L.

In accordance with one aspect, the present invention provides neat CNT concentrations of up to a concentration of about 3000 mg/L, up to about 2000 mg/L, up to about 1000 mg/L, up to about 750 mg/L, up to about 600 mg/L, or up to about 500 mg/L without the need for any dispersal aid, surfactant, binder, stabilizing polymer or other compound to facilitate dispersion such as graphene oxide (GO), acetylene glycols, or imidazolidinone compounds. In accordance with certain embodiments, the stable formulation provided herein consists essentially or consists of solvents in the solvent mixture used for preparing the finished composition from paste composed of oxidized CNTs. In accordance with certain embodiments, the present invention provides a stable CNT composition in which there is no need form film post-processing as all non-nanotube components are water/organic solvents, all removed upon evaporation of the wet film. Furthermore, in some cases the thermal processing necessary to remove the solvent(s) is usually about 80° C. or lower, suitable for plastic substrate (and therefore R2R) processing.

In accordance with some aspects of the present invention, carbon nanotubes are capable of forming stable matrices in various solvents by combining one or more monohydric alcohols with one or more diols. In accordance with some embodiments, the one or more of the first solvents about 5 and 95% and one or more of the second solvents comprise between about 5 and 95% by weight of the total formulation, or one or more of the first solvents comprise between about 20 and 95% and one or more of the second solvents comprise between about 5 and 80% by weight of the total formulation, or one or more of the first solvents comprise between about 40 and 95% and one or more of the second solvents comprise between about 5 and 60% by weight of the total formulation, or one or more of the first solvents comprise between about 50 and 80% and one or more of the second solvents comprise between about 15 and 50% by weight of the total formulation, or one or more of the first solvents comprise between about 55 and 75% and one or more of the second solvents comprise between about 15 and 35% by weight of the total formulation. The compositions disclosed herein may also include water in addition to the first and second solvents.

Table 1 provides boiling point data for various monohydric alcohols and diols that may be used in accordance with certain aspects of the present invention.

TABLE 1

| Monohydric | | | |
|---|---|---|---|
| alcohol | bp (° C.) | Diol | bp (° C.) |
| IPA | 83 | 1,2-butanediol | 192 |
| 1-butanol | 117 | propanediol | 188 |
| 1-pentanol | 138 | pentanediol | 206 |
| 3-hexanol | 135 | hexanediol | 223 |
| n-hexanol | 157 | | |
| cyclohexanol | 162 | | |
| 1-heptanol | 175 | | |
| 1-octanol | 195 | | |

### EXAMPLES

### Example 1—Slot Die Coating Trial

The following fluid matrix was prepared using purified carbon nanotube paste (measured about 0.18% solids as determined by TGA):
Cyclohexanol 30.32%
Ethylene glycol 29.22%
Water 12.9%
Isopropanol 27.57%

The composition was mixed via planetary centrifugal mixer followed by probe sonication. The stable supernatant composition was obtained/collected after ultracentrifugation. The carbon nanotube composition of the matrix optical density (absorbance a 550 nm) measured 14 and the concentration by mass balance was determined to be about 310 mg/L. Depositing the fluid in an approximately 50 micron thick wet film on a slot die coater, upon evaporation of solvent yielded a dry film that measured about 2000 ohms/sq at ˜90% film transmission in a single coat.

### Example 2—Dimatix Ink Jet Printing

The composition from Example 1 was diluted between about 20-70% solids using the described solvent blend and optimized inkjet parameters to facilitate stable jetting performance. Subsequent Dimatix ink jet printing enabled fabrication of transparent, conductive traces using minimal passes.

### Example 3—Pattern Transfer

The desired pattern to be transferred was underlaid the film to be printed. In the test case, the pattern to be transferred was a perforated sheet having mm-scale perforated holes. The metal perforated sheet was overlaid with a thin silicone film over which the substrate film to be printed was laid a coating “bird bar” was placed over the film (with either a 1 mil or four mil gap, as tested), a bead of fluid matrix with the composition described in Example 1 was deposited and a wet film was cast on top of the immobilized substrate film. Immediately observable was the pattern of the perforated sheet underneath that had transferred. Once the lower viscosity/higher boiling solvents were allowed to evaporate, the otherwise wet substrate was removed from the silicone sheet, and, holding the wet filmed vertically observed that the pattern remain fixed and did not run. Upon evaporation of the remaining solvent in an oven at about 80° C. it was observed that the pattern had indeed been completely transferred to the dry film.

### Example 4—Screen Printing

A second, solvent blend formulation was prepared by combining a similar purified carbon nanotube paste to yield the following final solvent composition:
Cyclohexanol 68.36%
1,2 propanediol 20.36%
Ethylene glycol 11.28%

The viscous carbon nanotube fluid was pipetted into a 305 mesh screen and upon printing and subsequent for solvent evaporation, a single screen print pass on to ST504 polyester substrate yielded a film that measured about 600 ohms/sq and about 86% film transmission. This example illustrates that a surfactant-free, polymer-free, and additive-free solvent mixture could be produced that was suitable for screen printing.

### Example 5—Neat NMP CNT Dispersion

The purified carbon nanotube paste used in Example 1 was added to neat n-methyl-pyrrolidinone (NMP) and probe sonicated. Subsequent purification via ultracentrifugation yielded a dark ink with an optical density (measured absorbance) at 550 nm of 38.

### Example 6—Neat Cyrene CNT Dispersion

The purified carbon nanotube paste used in Example 1 was added to Cyrene and probe sonicated. Subsequent purification via ultracentrifugation yielded a dark ink with an optical density (measured absorbance) at 550 nm of 33.

### Example 7—Cyrene Solvent Blend CNT Dispersion

In the formulation described in Example 1, cyclohexanol was replaced with Cyrene, which also enabled a stable ink that was slot-die coatable.

### Examples Based on Monohydric Alcohols and Diols

Inks were prepared according to the following general formulation:

Ink Formula A

| Material | Wt (g) |
|---|---|
| Oxidized CNT paste | 5.00 |
| IPA | 5.96 |
| water | 1.46 |
| Monohydric alcohol | 9.30 |
| diol | 8.96 |
| TOTAL | 30.68 |

The resulting inks were slot die coated with a 1 mil bar on 80° C. stage.

TABLE 2

| | Example 8 | Example 9 | Example 10 | Example 11 |
|---|---|---|---|---|
| Monohydric | 1-butanol | 1-octanol | 1-butanol | 1-octanol |
| alcohol | | | | |
| Diol | 1,2-butanediol | hexanediol | hexanediol | hexanediol |
| % T | 84.05 | 85.55 | 84.58 | 84.46 |
| | 82.81 | 84.64 | 84.24 | 84.37 |
| % H | 0 | 0.3 | 0 | 0.37 |
| | 0.4 | 0.4 | 0 | 0.4 |
| Rsheet | 8200 | 20000 | 9400 | 20000 |
| | 8200 | 30000 | 10000 | 30000 |
| | 6300 | 40000 | 20000 | 50000 |
| | 10000 | 30000 | 10000 | 20000 |

Inks Prepared with Non-Alcohols

Ink samples were prepared with non-alcohols in place of the monohydric and diols of Ink Formula A as provided below in Ink Formula B:

Ink Formula B

| Material | Wt (g) |
|---|---|
| Oxidized CNT paste | 5.00 |
| IPA | 5.96 |
| water | 1.46 |
| DMSO | 9.30 |
| cyrene | 8.96 |
| TOTAL | 30.68 |

The resulting inks were slot die coated with a 1 mil bar on 80° C. stage. Test results obtained are provided below in Table 3:

TABLE 3

| % T | % H | Rsheet |
|---|---|---|
| 80.72 | 0.37 | 4100 |
| 80.64 | 0.53 | 5600 |
| | | 4100 |
| | | 4300 |

The low boiling solvents (IPA and water) in the ink were removed via rotovap to provide a concentrated ink, which was probe sonicated for 20 s @ 60% amplitude. The resulting concentrated ink was recoated using a 1 mil bar on 80° C. stage. Test results obtained are provided below in Table 4:

TABLE 4

| % T | % H | Rsheet |
|---|---|---|
| 70.78 | 0.58 | 1500 |
| 71.59 | 0.51 | 1700 |
| | | 1700 |
| | | 2000 |

Samples were prepared and tested in accordance with the following procedures. The substrate (Melinex ST504) a high gloss, heat stabilized polyester film, was used as received, without any pretreatment such as corona or rinsing, etc.

The inks were coated using a bird bar having a gap thickness of 1 micron, where the ink was applied to the affixed substrate on a platen preheated to 80° C. surface temperature, where the ink was applied and then coated at approximately 200 mm/s coating speed. The ink fluid was allowed to evaporate on the heated stage, and once evaporated, only the carbon nanotube film composition remained on the ST504 substrate. No posttreatment was done other than additional oven heating at about 90° C. to ensure the solvent was completely evaporated.

Film properties were measured including sheet resistance with an Eddy current meter, as well as stack transmission and stack haze using a hazemeter. Each sample was prepared a single time and measured across the film in four places to determine sheet resistance and in two places to determine stack transmission and haze. The ST504 substrate by itself measures 89.5% T and 0.3% H.

To prepare the ink, a CNT paste composition composed of carbon nanotube material functionalized with a plurality of oxygen containing functional groups, where the paste is approximately 0.1% to 2.5% by weight carbon nanotubes. In accordance with certain embodiments, the CNT paste may be prepared based on the process disclosed in PCT/US2021/053319 or a similar process. The solvent blend, composed of water and/or a polar solvent, was probe sonicated in the presence of the prepared ink fluid blend for a total of about 0.5 s per mL of ink and then centrifuged.

In accordance with certain aspects, the composition of the functionalized carbon nanotube material in the final fluid matrix is between about 50 mg/L to about 1000 mg/L.

In a similar procedure, the paste composition and fluid matrix prepared above can be transferred to a rotovap and low boiling solvent components removed, to concentrate the fluid matrix in a high boiling composition only. Such a composition is useful for applications demanding a viscosity of about 20 cP to about 500 to 3,000 cP or more, such as screen printing.

Upon review of the description and embodiments of the present invention, those skilled in the art will understand that modifications and equivalent substitutions may be performed in carrying out the invention without departing from the essence of the invention. Thus, the invention is not meant to be limited by the embodiments described explicitly above and is limited only by the claims which follow.

1. A stable carbon nanotube fluid matrix comprising carbon nanotubes dispersed in a solvent mixture comprising a first solvent and a second solvent, wherein:
a) the first solvent has a boiling point below 100° C. and the second solvent has a boiling point above 100° C. or
b) the first solvent is a monohydric alcohol and the second solvent is a diol.

2. The stable carbon nanotube fluid matrix of claim 1, wherein the stable carbon nanotube fluid matrix is stable over a concentration range of from about 1 mg/L to about 3000 mg/L.

3. The stable carbon nanotube fluid matrix of claim 1, wherein the first solvent is selected from the group consisting of hexane, isopropanol, n-propanol, methanol, ethanol, benzene, acetonitrile, tetrahydrofuran, and mixtures thereof.

4. The stable carbon nanotube fluid matrix of claim 1, wherein the second solvent is selected from the group consisting of, propylene glycol methyl ether, dimethylformamide, n-methyl pyrrolidone, dimethylacetamide, dimethylsulfoxide, cyrene, butanol, toluene, xylenes, chlorobenzene, dichlorobenzene, ethylene glycol, propylene glycol, glycerol, methyl lactate, cyclohexanol, and mixtures thereof.

5. The stable carbon nanotube fluid matrix of claim 4, wherein the first solvent is selected from the group consisting of, isopropyl alcohol, ethanol, n-propanol, methanol, and mixtures thereof.

6. The stable carbon nanotube fluid matrix of claim 4, wherein the second solvent is cyclohexanol, ethylene glycol or propylene glycol.

7. The stable carbon nanotube fluid matrix of claim 1, wherein the solvent mixture comprises at least one monohydric alcohol and at least one diol.

8. The stable carbon nanotube fluid matrix of claim 1, wherein the solvent mixture comprises cyclohexanol, isopropyl alcohol and ethylene glycol.

9. The stable carbon nanotube fluid matrix of claim 1, wherein the stable carbon nanotube fluid matrix is free of surfactants, dispersant aids and polymers.

10. The stable carbon nanotube fluid matrix of claim 1, wherein the solvent mixture consists essentially of water, the first solvent and the second solvent.

11. The stable carbon nanotube fluid matrix of claim 1, wherein the carbon nanotubes are functionalized.

12. The stable carbon nanotube fluid matrix of claim 11, wherein the carbon nanotubes are functionalized with a plurality of oxygen containing functional groups.

13. The stable carbon nanotube fluid matrix of claim 1, wherein the carbon nanotubes are selected from the group consisting of single walled carbon nanotubes, multi-walled carbon nanotubes and mixtures thereof.

14. The stable carbon nanotube fluid matrix of claim 1, wherein the solvent mixture comprises ethylene glycol, cyclohexanol and propylene glycol.

15. The stable carbon nanotube fluid matrix of claim 1, wherein the solvent mixture comprises cyrene.

16. A stable carbon nanotube fluid matrix comprising functionalized carbon nanotubes dispersed in a solvent mixture, wherein the stable carbon nanotube fluid matrix is free of surfactants, dispersant aids and polymers and the stable carbon nanotube fluid matrix is stable up to a concentration of about 3000 mg/L.

17. A method of producing a stable carbon nanotube fluid matrix, comprising:
providing a carbon nanotube composition comprising oxidized carbon nanotubes; and
dispersing the carbon nanotube composition in a solvent mixture comprising a first solvent and a second solvent, wherein
a) the first solvent has a boiling point below 100° C. and the second solvent has a boiling point above 100° C. or
b) the first solvent is a monohydric alcohol and the second solvent is a diol to provide a stable carbon nanotube fluid matrix.

18. The method of claim 17, further comprising removing the first solvent from the carbon nanotube fluid matrix to produce a concentrated carbon nanotube fluid matrix.

19. A method of coating or printing on a substrate comprising:
providing the concentrated carbon nanotube fluid matrix of claim 18 and
printing or coating the concentrated carbon nanotube fluid matrix on a substrate.

20. The method of claim 19, wherein the concentrated carbon nanotube fluid matrix is screen printed on the substrate.

21. The method of claim 19, wherein the solvent mixture comprises ethylene glycol, cyclohexanol and propylene glycol.

22. A stable graphene fluid matrix comprising graphene dispersed in a solvent mixture comprising a first solvent and a second solvent, wherein:
a) the first solvent has a boiling point below 100° C. and the second solvent has a boiling point above 100° C. or
b) the first solvent is a monohydric alcohol and the second solvent is a diol.
